(19) United States
(12) Patent Application Publication
(10) Pub. No.: US 2005/0263682 A1
(43) Pub. Date: Dec. 1, 2005

(54) Dual prism/filter for narrowband photometry

(76) Inventor: Stephen Scott Eikenberry, Galnesville, FL (US)

Correspondence Address: AKERMAN SENTERFITT, P.O. BOX 3188, WEST PALM BEACH, FL, 33402-3188, US

(21) Appl. No.: 10/856,536

(22) Filed: May 28, 2004

(51) Int. Cl. H01J 3/14

(52) U.S. Cl. 250/216

(57) ABSTRACT

An optical bandpass separator and systems based thereon split target and continuum band signals. The separator includes a first optical path for selectively transmitting a target band signal. The first optical path includes a first prism and a first bandpass filter. The separator includes a second optical path non-overlapping with the first optical path for transmitting a continuum band signal. The second optical path includes a second prism and a second bandpass filter. The spacing of the first and second optical paths allows the simultaneous and separate imaging or detection of the target band signal and the continuum band signal using a single imager or detector.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

This invention relates to detection and imaging systems, in particular, to narrowband detection and imaging systems which separate a target absorption or emission band from a continuum band using a single measurement.

### BACKGROUND OF THE INVENTION

Infrared (“IR”) sensing arrays are widely used to capture images of objects that radiate in the infrared spectrum, generally defined as being in the wavelength range from about 750 nanometers to 1 millimeter. Each element of these sensing arrays use an infrared detector that reacts either to individual incident photons or to the total thermal energy caused by absorption of the incident photons to produce an electrical signal. The electrical signals produced by the sensing array are typically read out and processed to produce a digital electronic image indicative of an input IR scene.

In narrowband imaging, the goal is typically to measure the flux from a particular emission or absorption feature of interest in a known “target” wavelength range. For example, narrowband imaging can be used for landmine detection based on soil disturbances. Soil generally comprises a silica containing mixture of materials having a range of particle sizes. Natural processes tend to move the smaller particles in the soil mixture deeper into the soil. Excavation for mine burial brings the smaller particles to the surface, where they affect surface scattering. Silicate particles tend to be small particles which have a known distinct emission spectra which can be used to detect the presence of landmines, as recently excavated areas tend to have relatively high silicate concentrations as compared to the surrounding undisturbed earth.

However, as in the landmine example and other typical narrowband imaging applications, since broadband/continuum emission or absorption are present within the wavelength range of the feature of interest, typically two measurements are needed to determine the desired narrowband absorption or emission feature. A first intensity measurement is generally made in the “target” band (e.g. 1.866 to 1.884 μm) at a first time, and a second intensity measurement is then made in a broadband “continuum” band portion adjacent to the target band (e.g. 1.890 to 1.908 μm) at a time following the first time. The amplitude of the target band signal is generally much higher at its peak as compared to the amplitude of the relatively flat continuum band signal. The “continuum” flux from the second measurement is then subtracted from the “target” flux from the first measurement. The resulting excess or deficit in flux reveals the desired emission or absorption feature, respectively.

This process is typically performed in infrared astronomy using sequential observations using interference filter wheels. Such filter wheels have a plurality of rotatable wheel positions which include a plurality, such as five to seven, narrow bandpasses having pass bands which match several desired “target” bands and one “continuum” band.

Such a sequential imaging approach, however, does not work well when the background emission and (especially) atmospheric transmission in these bands is significant relative to the target line, and is also highly time-variable. The sequential nature of the measurement often creates confusion between absorption/emission in the “target” band with increased/decreased continuum signal between the time separated “target” and “continuum” measurements. This situation negatively impacts detection sensitivity, such as in the case of detection of landmines, as well as observations of scientifically significant features, including Paschen-α and Brackett-α features.

There are some photometry systems which provide simultaneous, or essentially simultaneous target and continuum measurements. These systems are generally dual-beam instruments which comprise a beam splitter, such as a dichroic beam splitter, for separating an incoming beam into two separate beams. A first beam comprises the target wavelength portion of the incoming beam. The second beam comprises the incident light beam less the target wavelength portion. The first beam is generally imaged on a first camera, while the second beam is imaged on a second camera. The cost of multiple camera systems is higher than the single camera systems because of reasons including the extra camera, lenses, and required synchronization electronics. Typical costs for such systems are in the range of $1 M to more than $5 M.

Accordingly, it would be beneficial to provide a low cost single beam imaging or detection system that is capable of acquiring an image or detecting the presence of the “target” bandpass separate from and simultaneous with the “continuum” bandpass using a single measurement.

### SUMMARY OF THE INVENTION

An optical bandpass separator for splitting target and continuum band signals includes a first optical path for selectively transmitting a target band signal. The first optical path includes a first prism and a first bandpass filter. The separator includes a second optical path non-overlapping with the first optical path for transmitting a continuum band signal. The second optical path includes a second prism and a second bandpass filter. A relatively small offset between the non-overlapping first and second optical paths allows the simultaneous and separate imaging or detection of the target band signal and the continuum band signal using a single imager or detector. As used herein, the term “light” generally refers to electromagnetic radiation including ultraviolet, visible and infrared radiation. However, the invention can be applied to shorter wavelength radiation such as x-rays, or longer wavelength radiation such as microwaves or radio waves.

The bandpass filters can be in physical contact with the prisms or in a spaced apart relation. In one embodiment, the bandpass filters comprise distributed Bragg reflector structures disposed on the respective prisms. The first and second prism are preferably oppositely-wedged and abutting prisms.

A narrowband photometry system includes at least one optical bandpass separator. The bandpass separator includes a first optical path comprising a first prism and a first bandpass filter for selectively transmitting a target band signal and a second optical path comprising a second prism and a second bandpass filter for transmitting a continuum band signal. The respective optical paths are non-overlapping. The system includes at least one of a single imager and a single optical detector. The imager or detector simultaneously receives the target band signal and the continuum band signal. The system can include a rotatable filter wheel comprising a plurality of filter positions, wherein at least one of said filter positions include the bandpass separator.

A method of splitting target and continuum band signals includes the steps of receiving a light beam comprising a target band signal, simultaneously splitting the light beam into the target band signal and a continuum band signal, and detecting the target band signal and the continuum band signal on a single imager or single detector. By using the bandpass separator according to the present invention, such as at the input focal plane of an imaging system, the invention provides two physically-adjacent simultaneous images of the same field, one in each of the target and an adjacent portion of the continuum band. Through subtraction of the continuum band data from the target data, noise introduced by time variation in the atmospheric transmission and/or background can be eliminated.

### BRIEF DESCRIPTION OF THE DRAWINGS

A fuller understanding of the present invention and the features and benefits thereof will be accomplished upon review of the following detailed description together with the accompanying drawings, in which:

FIG. 1 shows an optical bandpass separator according to an embodiment of the invention embodied as a dual prism filter.

FIG. 2 shows an exemplary imaging system including an optical bandpass separator, according to an embodiment of the invention.

FIG. 3 shows an encircled energy diagram obtained from a Canarias InfraRed Camera Experiment (CIRCE) instrument including a Pa-α filter/prism device according an embodiment of the present invention. CIRCE is a near-infrared camera for the 10.4-meter Gran Telescopio Canarias (GTC) located in the Canary Islands, Spain.

### DETAILED DESCRIPTION OF THE INVENTION

The present invention is more particularly described below and is intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

An optical bandpass separator for splitting target and continuum band signals includes a first optical path for selectively transmitting a target band signal. The first optical path includes a first prism and a first bandpass filter. The separator includes a second optical path non-overlapping with the first optical path for transmitting a continuum band signal. The second optical path includes a second prism and a second bandpass filter. The relatively small spatial offset between the non-overlapping first and second optical paths allows the simultaneous and separate imaging or detection of the target band signal and the continuum band signal using a single imager or detector.

As noted in the background, the sequential nature of conventional imaging systems for separating continuum and target lines creates confusion between absorption/emission in the target band with increased/decreased background/transmission occurring between the target and continuum measurements. By using the bandpass separator according to the present invention, such as at the input focal plane of an imaging system, the invention provides two physically-adjacent simultaneous images of the same field, one in each of the target and an adjacent portion of the continuum band. As a result of the respective target and continuum data being obtained simultaneously, through subtraction of the continuum band data from the target data, the invention can eliminate noise introduced by time variation in the atmospheric transmission and/or background. As such, the present invention is capable of achieving highly sensitive measurements of narrowband line features even under time-variable conditions and thus overcomes the sequential sequencing limitations inherent in conventional narrowband imaging systems.

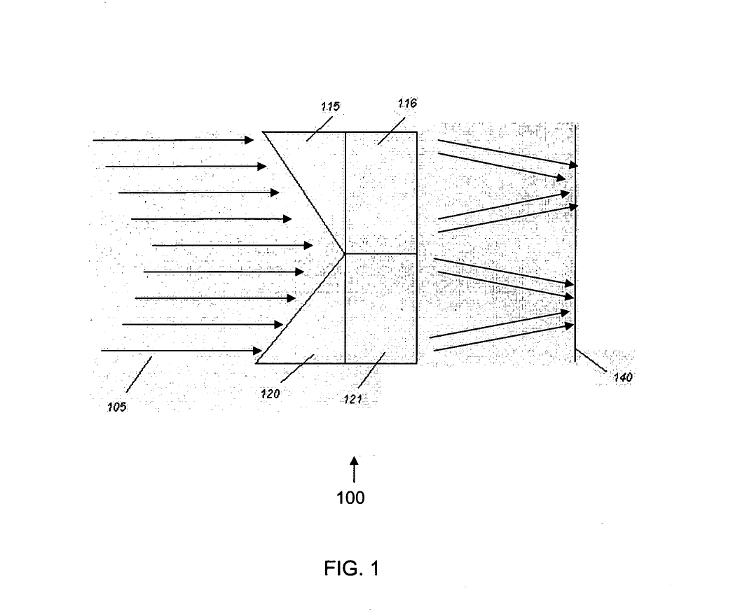

Referring to FIG. 1, optical bandpass separator 100 according to an embodiment of the invention is shown together with a detector 140. The optical bandpass separator 100 shown is embodied as a dual prism/filter 100. The dual prism filter 100 includes two wedge shaped prisms 115 and 120, each having a band pass filter 116 and 121, respectively, disposed thereon. The prisms 115 and 120 are oriented in a non-overlapping configuration such that incident light passes through either prism, but not both prisms. In a preferred embodiment, the prisms 115 and 120 are disposed in a side-to-side configuration as shown in FIG. 1.

The prism shape is selected based on well known optics to achieve a desired image shift at the plane of detector 140. Prisms can be formed from materials such as IR grade quartz or CaF₂. Although not shown, prisms 115 and 120 can be coated with a suitable anti-reflective coating layer.

Light 105 is incident on the surface of both prisms 115 and 120. Prisms 115 and 120 are shaped to achieve a desired image shift at detector plane 140. An exemplary detector 140 is a Rockwell Hawaii 1024×1024 HgCdTe array.

One filter substantially transmits in the “target” or “object” band, such as filter 116, while the other filter, such as filter 121, substantially transmits in the “continuum” or “background” band. Although the dual prism filter 110 shown in FIG. 1 utilizes filters 116 and 121 in physical contact with prisms 115 and 120, respectively, dual prism filter 110 can use optically aligned prism and filter pairs disposed in a spaced apart relation (not shown).

The bandpass filters 116 and 121 are preferably embodied as multilayer thin film structures referred to as distributed Bragg reflectors or mirrors. In the embodiment shown in FIG. 1 using Bragg reflectors, prisms 115 and 120 are coated with an alternating stack of high and low index of refraction thin film layers, with each layer having an optical thickness conventionally being one quarter of the resonant wavelength value (i.e. λ4). This thicknesses of the layers results in the light reflected by all the high and low refractive index interfaces interfering negatively within a spectral range further referred to as the stop-band. In high-quality structures, reflectivity of Bragg mirrors within the stop-band generally exceeds 99%. Other bandpass filter embodiments known to those having ordinary skill in the art, such as metal-dielectric filters, may also be used with the invention.

Although shown disposed on the side opposite the beam incident side of the prisms 115 and 120, in an alternate arrangement (not shown) the bandpass filters 116 and 121 can be disposed on the beam incident side of the respective prisms 115 and 120. The arrangement shown in FIG. 1 has an advantage over the alternate arrangement in that it keeps the filters 116 and 121 flat.

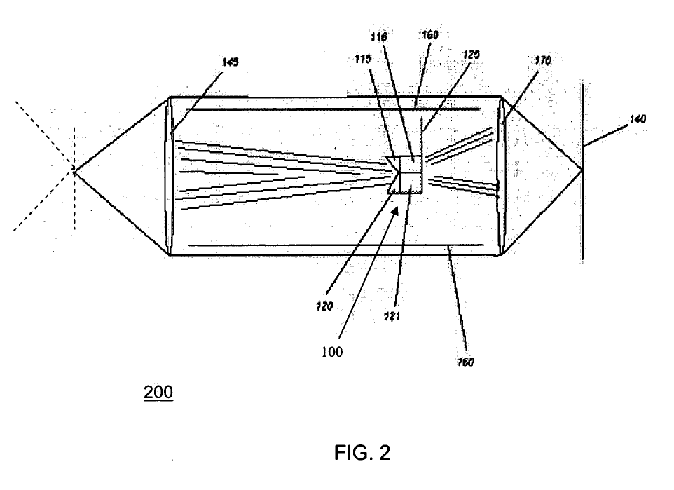

FIG. 2 shows an exemplary imaging system 200 according to an embodiment of the invention. System 200 includes a first collimator 145 which can comprise a plurality of lenses (not shown) and a filter wheel 125 where at least one of the plurality of positions on the wheel include optical bandpass separator 100. Although not shown, a re-imaging section comprising a collimator can be disposed between the separator 100 and the camera 170. System also generally includes a radiation shield 160.

When imaging, dual prism filter 100 results in the target band passed by one filter and a continuum bandpass passed by the other filter, each preferably occupying about one-half of the pupil plane provided by camera 170. As such, the present invention achieves two physically-adjacent simultaneous images of the same field. As a result of the images being obtained simultaneously, the noise introduced by time variation in the atmospheric transmission and/or background is eliminated. Consequently, when the signals are detected by detector 140, the subtraction process described above can proceed to produce very accurate readings of narrowband line features independent of often variable background conditions.

The invention can be used with new detection or imaging systems or used to retrofit existing systems. Existing systems can be quickly retrofitted by replacement of the filter wheel with a filter wheel having at least one bandpass separator according to the invention.

A recent development in sequential filtering that may eliminate the need for a rotating wheel in certain applications is the tunable filter. The tunable filter is a single filter whose wavelength of transmission can be varied electronically (often with an acoustic pulse) at speeds as fast as about 50 ms. Bandwidths as small as 0.1 nm can be utilized. The view angle of such filters can be as much as +20. Currently, the major limitations of these filters are low transmission (less than 30%), and separate filters must be used for the visible and near-IR spectrum. For a system to benefit from tunable filters, the detectors employed by the system must generally have read out times that at are least comparable to the switching speed of the tunable filter. Thus, in the field of astronomy, tunable filters currently provide no significant advantage because astronomy systems now employ detectors which have readout times of about 1 second.

Although generally described with reference to astronomy systems, the invention is expected to have wide variety of applications beyond astronomy. For example, the invention may used for applications including surveillance, materials characterization, plasma diagnostics, biological measurements, and military operations, where narrowband measurements are beneficial under time-variable conditions.

With regard to military applications, remote imaging such as using aircrafts can be improved using the invention, including remote land mine detection or enemy detection. A variety of materials which can be used to indicate the presence of explosives via chemical tracers have not been relied on for detection to date due to time variability of sequential emission or absorption measurements and the resulting loss in sensitivity. The invention can thus be used to improve homeland defense through the ability to detect explosives using remote imaging for a range of chemical tracers much wider than available prior to the invention.

The invention also provides medical applications. One exemplary medical application is Single photon emission computed tomography (SPECT) which has been used to study a radionuclide distribution in a subject. Typically, one or more radiopharmaceuticals or radioisotopes are injected into a patient subject. The radioisotope preferably travels to an organ of interest whose image is to be produced. The patient is placed in an examination region of the SPECT system surrounded by large area planar radiation detectors. Radiation emitted from the patient is detected by the radiation detectors. The detectors have a mechanical collimator to limit the detector to seeing radiation from a single selected trajectory or ray, often the ray normal to the detector plane.

Typically, the detector includes a scintillation crystal that is viewed by an array of photomultiplier tubes. The relative outputs of the photomultiplier tubes are processed and corrected, as is conventional in the art, to generate an output signal indicative of (1) a position coordinate on the detector head at which each radiation event is received, and (2) an energy of each event. The energy is used to differentiate between emission and transmission radiation and between multiple emission radiation sources and to eliminate stray and secondary emission radiation. A two-dimensional projection image representation is defined by the number of radiation events received at each coordinate. Bioluminescence processes may also be monitored using the invention.

### EXAMPLES

The present invention is further illustrated by the following specific examples, which should not be construed as limiting the scope or content of the invention in any way.

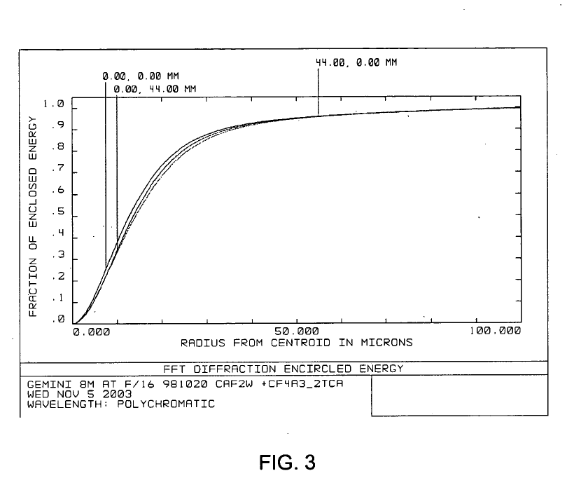

FIG. 3 shows an encircled energy diagram obtained from a Canarias InfraRed Camera Experiment (CIRCE) instrument including a Pa-α filter/prism device according an embodiment of the present invention. CIRCE is a near-infrared camera for the 10.4-meter Gran Telescopio Canarias (GTC) located in the Canary Islands, Spain. The data in FIG. 3 demonstrates that systems including filter/prism devices according to the invention provide good image quality in a typical astronomical infrared array camera.

Although the illustrative embodiments of the present disclosure have been described herein with reference to the accompanying drawings and description, it is to be understood that the disclosure is not limited to those precise embodiments, and various other changes and modifications may be affected therein by one skilled in the art without departing from the scope of spirit of the disclosure. All such changes and modifications are intended to be included within the scope of the disclosure as defined by the appended claims.

1. An optical bandpass separator for splitting target and continuum band signals, comprising:
a first optical path for selectively transmitting a target band signal, said first optical path including a first prism and a first bandpass filter, and
a second optical path non-overlapping with said first optical path for transmitting a continuum band signal, said second path including a second prism and a second bandpass filter, wherein a spacing of said first and second optical paths allow simultaneous imaging or detection of said target band signal and said continuum band signal using a single imager or detector.

2. The separator of claim 1, wherein said bandpass filters are in physical contact with said prisms.

3. The separator of claim 2, wherein said bandpass filters comprise distributed Bragg reflector structures.

4. The separator of claim 1, wherein said bandpass filters are spaced apart from said prisms.

5. The separator of claim 1, wherein said first prism and said second prism comprise oppositely-wedged prisms.

6. A narrowband photometry system, comprising:
at least one optical bandpass separator, said bandpass separator including a first optical path for selectively transmitting a target band signal, said first optical path including a first prism and a first bandpass filter, and a second optical path non-overlapping with said first optical path for transmitting a continuum band signal, said second path including a second prism and a second bandpass filter, and
at least one of a single imager and single optical detector, said single imager or detector simultaneously receiving said target band signal and said continuum band signal.

7. The system of claim 6, wherein said system includes a rotatable filter wheel, said filter wheel comprising a plurality of filter positions, wherein at least one of said filter positions include said bandpass separator.

8. The system of claim 6, wherein said imager comprises a camera.

9. The system of claim 8, further comprising said detector.

10. The system of claim 6, wherein said bandpass filters are in physical contact with said prisms.

11. The system of claim 10, wherein said bandpass filters comprise distributed Bragg reflector structures.

12. The system of claim 6, wherein said bandpass filters are spaced apart from said prisms.

13. The system of claim 6, wherein said first prism and said second prism comprise oppositely-wedged prisms.

14. A method of splitting target and continuum band signals, comprising the steps of:
receiving a light beam comprising a target band signal;
simultaneously splitting said light beam into said target band signal and a continuum band signal, and
detecting said target band signal and said continuum band signal on a single imager or single detector.

15. The method of claim 14, wherein said detecting step comprises simultaneous imaging of physically-adjacent images of said target band and said continuum band.
